(19) United States
(12) Patent Application Publication
(10) Pub. No.: US 2005/0183426 A1
(43) Pub. Date: Aug. 25, 2005

(54) Frozen dessert dispensing machine

(76) Inventor: Douglas A. Learned, Carmel, CA (US)

Correspondence Address: FULWIDER PATTON LEE & UTECHT, LLP;HOWARD HUGHES CENTER, 6060 CENTER DRIVE, TENTH FLOOR, LOS ANGELES, CA, 90045, US

(21) Appl. No.: 10/786,723

(22) Filed: Feb. 24, 2004

(51) Int. Cl. F25C 1/18; A23G 9/00

(52) U.S. Cl. 62/68; 62/342

(57) ABSTRACT

A dessert machine is provided that produces a frozen dessert product. Frozen fruit and water are ground and spun with air introduced to create a frozen creamy smooth dessert. The frozen dessert machine has a distally tapered auger, having a spiral thread, that mixes the dessert ingredients into the desired consistency. The invention involves an electronic control system that ensures quality reproduction with every dessert produced. Additionally, the dessert machine provides safety interlocks for enhanced operator safety during production of the dessert product.

### BACKGROUND OF THE INVENTION

This invention relates to a machine for producing a frozen dessert, and more particularly to an apparatus that dispenses a creamy, smooth dessert made of frozen fruit and water.

Frozen dessert drinks and smoothies are very popular. These drinks are sold in restaurants, convenience stores and specialty stores as well. Many different types of frozen desserts are now available and there are made to order desserts and frozen syrup based desserts that are prepared in mass quantities and retained in a cooling chamber until dispensed for consumption. Since the equipment to make and dispense such desserts has been available, they are often placed on a counter where it is readily accessible to the person responsible for operating, maintaining and servicing the equipment. Frozen drinks of this type may be formed of ice, frozen yogurt, sorbet, and may include additives such as fresh or frozen fruit, berries, fruit juices or water, and vitamins.

While there are many makes and designs of machines for producing frozen desserts, most of them operate on a principle requiring a mixture of frozen and un-frozen materials to be fed into a mixing chamber, cooling or freezing the mixing chamber, adding or whipping air into the mixture, mixing or blending the mixture into a confection, and dispensing the frozen confection into a desired receptacle. A problem with the existing machines is that they are manually operated, that is, there is a drive motor for the mixer, but there is a hand lever which is used to press down on the mixing instrument as it is forced into the receiving cone to mix the product.

Further limitations to the existing machines that produce a fresh product include the required physical input of the operator which is determinative of the speed and mixing quality of the materials in the machine and thus the quality of the dessert made. A machine operator possessing average adult strength will provide more pressure to the hand lever mechanism than a smaller operator not possessing average adult strength. The amount of force extended is related to the degree of aeration, mixing and particulate size of the dessert product. Consistent levels of asserted pressure coupled with consistent mixing times further improve the probability for a desired consistency of the product.

Other machines produce frozen desserts in large quantities which are pre-blended and held in a cooling compartment for an extended period of time, sometimes several hours, wherein there is no consistency of quality of the finished product.

Employee safety is a major concern of restaurant owners. Industrial accidents reduce employee productivity and cause expensive equipment down time. Safeguards to prevent operator injury from moving parts during operation of the frozen dessert machines has not been a major design factor in the existing machines.

What has been needed is a frozen dessert machine accepting frozen fruit and other ingredients which can be prepackaged for simple placement into a machine which safely mixes the ingredients regardless of operator strength or skill and a method of dispensing the confection product after it has achieved a desired consistency. The present invention addresses these and other needs.

### SUMMARY OF THE INVENTION

Briefly, and in general terms, the present invention provides for an apparatus for producing a creamy frozen dessert product to be consumed by a consumer. The present invention provides several advantages over the prior art. For example, the present invention provides an electronic control system that mixes the dessert ingredients for a predetermined time, thereby consistently producing a quality product.

The invention accordingly provides for an apparatus for preparing a frozen dessert product comprising a housing attached to a mountable base. The base can be mounted on a cabinet or counter and it is configured to support the housing. A receiving chamber is pivotally attached to the housing. A predetermined quantity of frozen dessert ingredients is inserted into the receiving chamber for mixing.

A mixing auger is rotatably mounted in the dessert machine housing. The auger is distally tapered and extends downward into the receiving chamber when the receiving chamber is in a vertical position. An electronic control system controls the vertical movement of the auger, that is, lowering the auger into the receiving chamber for mixing the ingredients and for incrementally raising the auger in the receiving chamber during production of the frozen dessert product. An AC stepper motor controls the up and down motion of the auger and a supporting carriage assembly. The small incremental auger motions allow more consistency in the dessert product.

The electronic control system also initiates power commands to a DC main drive motor that rotates the auger. The advantage of the DC motor is that it provides high torque at relatively low RPM. A microprocessor signals commands to the controlled rotation of the auger, thereby controlling the auger RPM and feed rate to optimally produce a frozen dessert product of consistent quality. The distally tapered auger includes a spiral thread for mixing the frozen ingredients and forcing the mixture into a downward spiral into the dispensing outlet. The microprocessor is programmed to mix the frozen dessert ingredients for a predetermined time in order to achieve the desired consistency. In practice, it was necessary to extensively experiment with the configuration of the various components and the computer programmed operation and interlocks to achieve the desired operation of the invention. Thus, the development of the invention was significantly influenced by the desire to enhance safety over conventional machines and improve the quality of the product produced for a wide variety of operations and ingredients which could be part of the dessert being made, thus taking the operator skill out of the equation for producing a quality dessert employing a wide variety of ingredients. The present invention has solved these and many other problems of operator safety and capability, essentially reducing the operator's role to loading the machine with prepackaged ingredients, dispensing the product and initiating a cleaning cycle when necessary The receiving chamber is conically shaped and includes an open top section and a coned bottom section having a closed configuration for mixing the ingredients, the bottom section further having an operable configuration for dispensing the frozen dessert product. Suitable materials for the auger and receiving chamber include alloys of aluminum and stainless steel. Non-stick coatings are applied to the aluminum surfaces to prevent product adherence and to facilitate cleaning of the product.

Safeguards for the frozen dessert machine include a safety interlock system that inhibits auger rotation until a rotation command is initiated by the interlock system. In a presently preferred embodiment, at least three interlock conditions are verified before the auger rotation command is initiated, including: 1.) the receiving chamber is secured in an upright position, that is a non pivoted position; 2.) the safety shield is in position; and 3.) the auger is lowered into the receiving chamber. The order of the safety interlock inquiries may vary according to the operational steps for the machine, but at least these three conditions must be sensed before the microprocessor program initiates operation.

The pivoting receiving chamber can present a hazardous operation condition if the chamber is not secured in the upright position. A safety shield prevents the operator's fingers or limbs from contacting the rotating auger during operation of the frozen dessert machine. The dessert machine electronic control system is programmed to inhibit the drive motor command when the safety shield is not in a safeguard position, thus preventing rotation of the auger. The safety shield also prevents frozen or unfrozen ingredients from projecting out of the receiving chamber onto the operator.

For enhanced safety, the auger positioning safety interlock inhibits auger rotation when the auger is elevated above the receiving chamber, wherein the operator is susceptible to finger or limb injury from a rotating auger. The safety verification system assures that both the auger is lowered into the receiving chamber and that the safety shield is in a protective position before the mixing cycle is initiated.

In another aspect, the present invention provides a frozen dessert machine that is easy to clean. The mixing auger is configured to emit a rinse fluid through and out of the rotating auger for cleaning purposes. The auger is formed with a plurality of holes through which the rinse fluid flows into the receiving chamber. The fluid is emitted from the auger as the auger rotates, thereby projecting thrashing water against the container walls or safety shields for cleaning purposes after production of the frozen dessert product. All of the exterior aluminum surfaces of the dessert machine are hard anodized for wear and ease of cleaning. An automatic rinse cycle is programmed into the microprocessor, and a manual rinse cycle may be initiated by a control unit located on the dessert machine housing.

From the above, it may be seen that the present invention overcomes many limitations of prior art dessert making machines by eliminating operator skill and strength from the process, while creating a more consistent product. The use of a microprocessor to control the operation of the machine allows for programming the speed, force and vertical motion of the auger to create a desired result for a variety of ingredients. Also, the program includes safety interlocks which substantially reduce the chance of operator injury or of product being sprayed out of the machine during operation, while maintaining the essentially automated operation of the machine. These and other aspects of the invention will become apparent from the following detailed description and the accompanying drawings, which illustrate by way of example the features of the invention.

### BRIEF DESCRIPTION OF THE DRAWINGS

FIG. 1 is a perspective view of a frozen dessert dispensing machine of the present invention;

FIG. 2 is a view of the operating control panel;

FIG. 3 is a block diagram of the electronic control system;

FIG. 4 is a view of the mixing auger elevated above the receiving chamber;

FIG. 5 is a block diagram of the electronic control system depicting the electric motors that control the auger rotation and vertical movement; and

FIG. 6 is a flow diagram of the safety interlock system.

### DETAILED DESCRIPTION OF THE PREFERRED EMBODIMENTS

As shown in the drawings, which are included for the purpose of illustration and not by way of limitation, the invention is embodied in an apparatus and method for preparing a frozen dessert. In one aspect, the invention is embodied in a machine that produces the frozen dessert product. In operation the machine uses frozen fruit and water which are ground and spun with air introduced during the process to create a frozen, creamy, smooth dessert. The frozen dessert machine includes a distally tapered auger, having a spiral thread, that mixes the dessert ingredients into the desired consistency. The apparatus of the invention includes an electronic control system that ensures quality production of every dessert. In a presently preferred embodiment, a means for cleaning the machine after use is provided, as well. Additionally, the dessert machine of the invention provides safety interlocks for enhanced operator safety during production of the dessert product.

Those skilled in the art will recognize that there are many makes and designs of machines for producing frozen desserts, most of them operating on a principle requiring a mixture of frozen and un-frozen materials to be fed into a mixing chamber, cooling or freezing the mixing chamber, adding or whipping air into the mixture, mixing or blending the mixture into a confection, and dispensing the frozen confection into a desired receptacle. The presently preferred embodiment of the invention produces a healthy and safe food product in an efficient and safe way, regardless of operator's skill or strength. The dessert product provides a good source of fruit nourishment for children and adults, as well as, providing an alternative to other dessert products that are less healthy, consisting primarily of syrup and/or coffee ingredients.

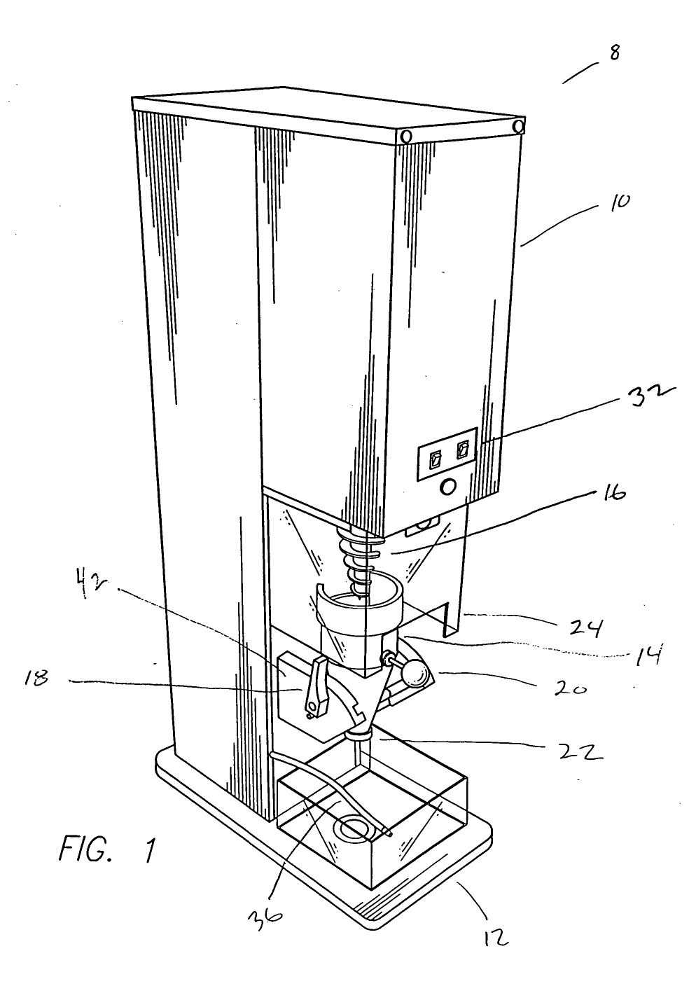

As illustrated in FIG. 1, the frozen dessert machine 8 of the present invention is shown embodied in a housing 10 that is attached to a base 12. The base 12 is configured to support the dessert machine housing 10. The base 12, being mountable on a cabinet or counter, stabilizes the dessert machine during the operation cycle. Furthermore, the base 12 provides a drainage port for liquid run-off from a drainage hose 36 during the preparation cycle, and liquid run-off during the cleaning cycle. While chilling or freezing the receiving chamber produces condensation, the run-off drains through drainage hose 36.

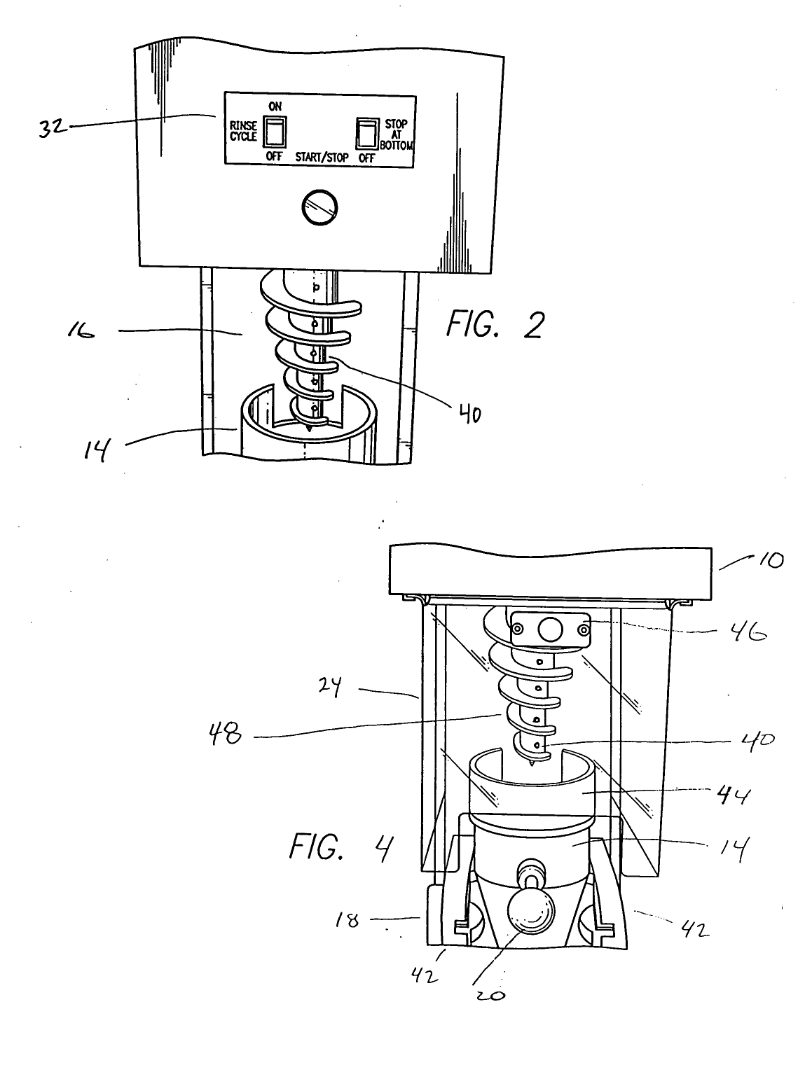

In the presently preferred embodiment of the invention, as shown in the FIGS. 1-2, the frozen dessert machine housing 10 includes a command panel 32, a mixing auger 16, a mixing or receiving chamber 14, and safety shields 24. An electronic control system comprising a microprocessor controller is located within the housing 10. The computer based electronic control system initiates control commands for mixing the frozen dessert product.

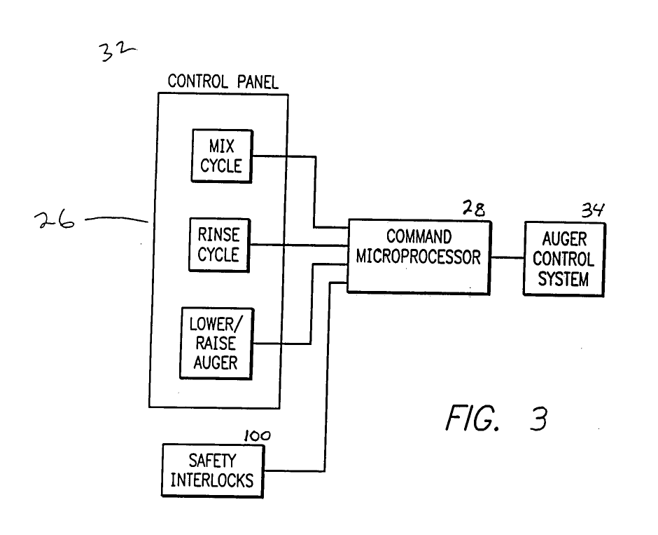

FIG. 3 illustrates an operation diagram of the electronic control system 26. An operator initiates function commands on the control panel 32, the micro-processor processes the function commands 28, verifies the safety interlocks 100 and initiates control commands to the auger control system 34. For example, the auger operation may be commanded to lower the auger into the mixing receptacle, and the auger can be commanded to rotate in a mixing cycle as determined by the operator, or the auger can be commanded to initiate a rotating rinse cycle. For safety precautions, the auger rotation commands are initiated after the satisfaction of the safety interlock system.

Using a computer controlled mix cycle, operator characteristics, such as physical ability, are removed from the process of producing the frozen dessert. A drive motor rotates the auger 16 for a predetermined time when the operation or mix cycle is initiated. The auger is rotatably attached within the dessert machine housing 10, having a distally tapered shaft extending downwards towards the housing base 12. The auger 16 has two vertical positions, one elevated above the receiving chamber, as shown in FIG. 4, and the second position lowered into the receiving chamber 14. Prior to initiating the mix cycle, the auger 16 is lowered into a receiving chamber wherein frozen and unfrozen dessert ingredients are inserted and thereafter mixed or blended with air to produce the creamy frozen dessert product. While the drive motor rotates the auger, a spiraling horizontal thread 48 protruding from the auger 16 mixes the dessert ingredients and moves the mixture in a downward spiral.

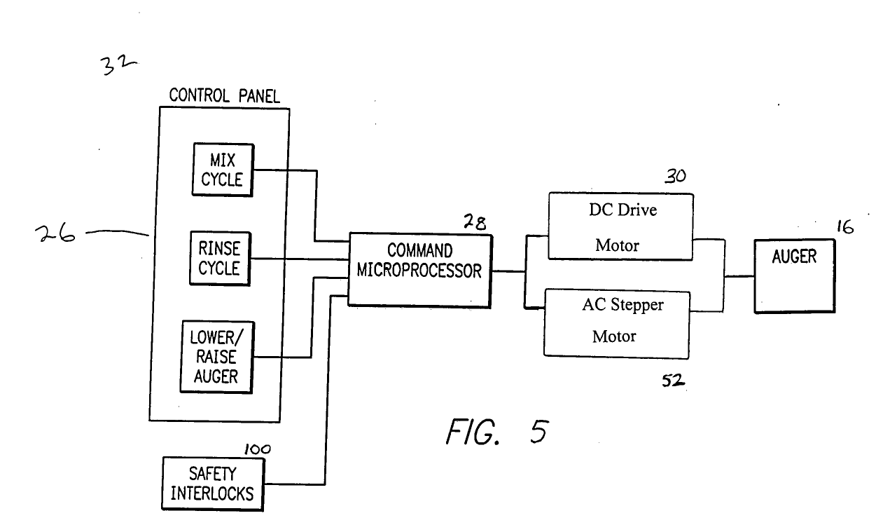

Referring to FIG. 5, the electronic control system of the preferred embodiment of the invention includes two electric motors for auger control and quality production of the frozen dessert. The main auger motor is a DC main drive motor 30 controlling the rotation of the auger and providing high torque at relatively low RPM. The second electric motor 52 controls the vertical movement of the auger and a supporting carriage assembly (not shown). Preferably, an AC stepper motor 52 is used to control the up and down motion of the carriage in very small increments which advantageously allows for more consistency in the dessert production. The carriage rides on linear bearings to provide a very low coefficient of friction and at the same time giving rigidity to the machine, as grinding frozen fruit juice and water into a creamy smooth consistency requires a very accurate interface between the auger and the mixing chamber. Both the DC motor and the AC stepper motor are controlled by the command microprocessor 28. The control of the auger RPM and feed rate is accomplished by programmable memory in the microprocessor which is optimized for product consistency and operator simplicity.

The stepper motor 52 is mounted at the top of the dessert machine assembly and connected by a coupling to a ball screw. Those skilled in the art will appreciate the advantages of this application, e.g. the ball screws inherently low friction and the ability to be accelerated and decelerated over long periods of time with minimal wear, as compared to ACME threaded screws used in similar applications. Another advantage of the ball screw application is the very low noise output. Since the dessert machine is used in a kitchen environment or a point of sale kiosk, low level noise is a necessity. The ball screw accompanied with the linear ball bearing add to the quiet operation of the dessert machine.

The frozen dessert machine 8 is plugged into an AC voltage receptacle to power the various electrical devices mounted in the dessert machine housing 10. The DC motor includes a DC motor controller that converts AC voltage to DC voltage. The DC motor runs at one fixed RPM. The AC stepper motor runs at various RPMs depending on where it is in the operation cycle, as controlled by the programmable memory which communicates with the AC stepper motor. A series of micro-switches tell the AC stepper motor where it is in relationship along its traveled path. When a micro-switch is triggered, the controller tells the AC stepper motor where it is and what is the next corresponding RPM and/or what count it needs to perform, thus, eliminating the AC stepper motor being stuck because the product is frozen to hard and the motor is not able to propel the carriage downward.

The distally tapered auger 16 is formed from a durable material to ensure a lasting quality. Auger materials may include metal alloys of aluminum or stainless steel, as well as durable thermo plastic compositions, subject to the requirement that the auger must be sufficiently durable to endure engagement of frozen fruit particles and ice which may be included during preparation. Suitable materials for the auger 16 and receiving chamber 14 include aluminum that is a forged billet of 6061 aluminum. An advantage of using aluminum is that it will cool down quicker than conventional materials used and will enable the dessert product to be processed the first time as an acceptable, quality, dessert.

In a presently preferred embodiment, the auger is conical with an included top diameter of the auger of 3¾ inches and a bottom tip diameter of 1 inch. The auger height is 6½ inches.

An automatic rinse cycle is programmed into the microprocessor, and a manual rinse cycle may be initiated by a control unit located on the dessert machine housing. A plurality of holes 40 on the auger shaft are configured to emit a rinsing fluid during the rinse cycle (FIG. 4). In a presently preferred embodiment 8 (eight) holes are used for the flushing in the auger. During the rinse cycle the rinse fluid, which may be water or a water based detergent, flows through and out of the holes 40 on the rotating auger 16, thereby removing fruit seeds or other sediments which may become lodged within the mixing auger. The fluid is emitted from the auger as the auger rotates, thereby projecting a fluid stream against the container walls or shield 24 for cleaning purposes. Proprietary coatings are applied to both the auger 16 and receiving chamber 14 to facilitate the product not adhering to either surface and to facilitate rinsing of the product during clean up. One coating that is universally used for non-stick surfaces is XYLAN™. The receiving chamber 14 may be coated with a XYLAN-8840/891 material. All exterior aluminum surfaces of the machine are hard anodized for wear and ease of cleaning.

A receiving chamber 14 receives the dessert ingredients during the pre-mixing cycle and at the beginning of the mix cycle, it receives the auger. The receiving chamber, being conically shaped, includes a relatively large open top section and a smaller coned bottom section having a closed configuration for mixing the ingredients, and the bottom section further having an operable open configuration for dispensing the frozen dessert product. The frozen dessert is dispensed through a dispensing outlet 22 on the distal tip of the receiving chamber 14 into a container for consumption by the consumer. In a presently preferred embodiment, the receiving chamber is conical with an included upper, outer, diameter of 5 inches and a bottom diameter of 2 inches. The receiving chamber height is 10 inches.

The receiving chamber 14 is pivotally attached to the dessert machine housing 10. The housing includes two diametrically opposed mounting arms 42 wherein the conical shaped receiving chamber 14 is pivotally attached there between (FIG. 4). In the non-operable position the operator can pivot the receiving chamber diagonally using a locking lever 18. The receiving chamber 14 pivots or tilts approximately 45° away from the housing 10. The pivoted receiving chamber provides easy access for inserting the frozen dessert ingredients, and also for cleaning the machine after use. To further facilitate the ease of the pivot mechanism, a handle 20 is fixedly attached to the outer surface of the conical receiving chamber 14. The handle 20 may include a knobbed attachment for use in pivoting the receiving chamber. Alternatively, the pivot mechanism may be operated by an electric motor or the like and its operation inhibited unless the auger is withdrawn and not rotating. The receiving chamber further includes an upper cylinder wall 44 configured to prevent interference with the auger during receiving chamber pivoting.

An advantage of the present invention is to provide a frozen dessert machine having safety interlocks for operator safety during production of the frozen dessert. Preferably, safeguards are provided that prevent injury due to operator contact with the rotating mixing utensil. Safeguards for the frozen dessert machine include a safety interlock system 26 that inhibits auger rotation until a rotation command signal is initiated by the safety interlock system 100 and received by the command microprocessor 28.

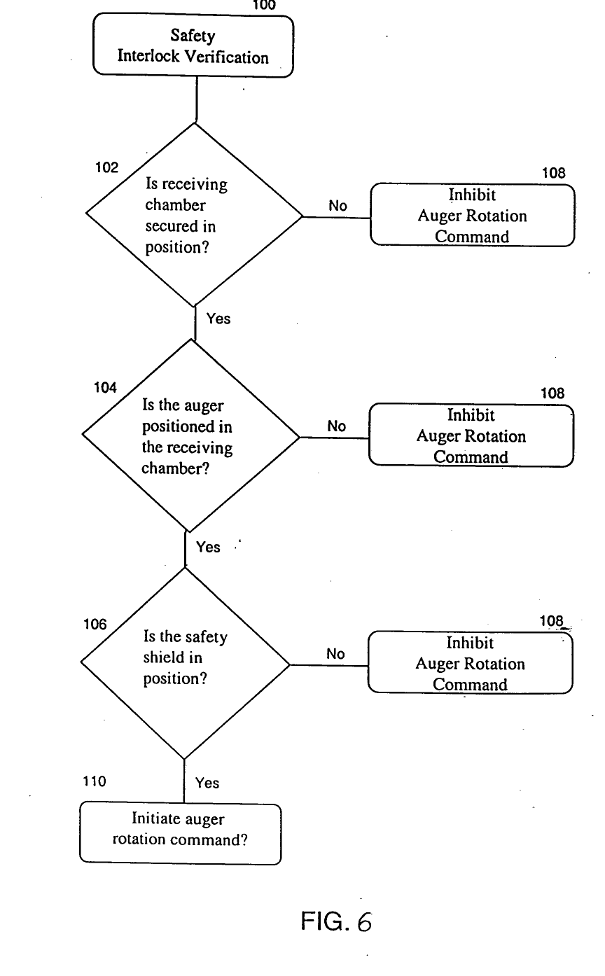

As illustrated in FIG. 6, at least three interlock conditions are verified before the auger rotation command is initiated, the conditions include: 1.) Is the receiving chamber secured in an upright position, that is a non pivoted position? 2.) Is the safety shield in position? 3.) Is the auger lowered into the receiving chamber? The order of the safety interlock inquiries may vary. Additional safety interlock conditions may be programmed into the microprocessor according to the desired level of safety required. If the safety interlock condition is not satisfied, an “inhibit auger rotation” command 108 is sent to the microprocessor 28.

If the pivoting receiving chamber 14 is not secured in the upright position, a hazardous operation condition may result. Therefore, the control lever 18 should be secured prior to initiating the auger rotation command 110. A safety shield 24 prevents the operator's finger or other limbs from contacting the rotating auger 16 during operation of the frozen dessert machine 8. The dessert machine safety interlock system 100 is programmed to inhibit the drive motor command when the safety shield is not in a safeguard position, thus preventing rotation of the auger. The safety shield 24 also prevents frozen or unfrozen ingredients from being propelled out of the receiving chamber 14 onto the operator. A safety shield attachment mechanism 46 attaches the shield to the housing assembly 10.

For enhanced safety, the auger positioning safety interlock inhibits auger rotation when the auger is elevated above the receiving chamber, thereby reducing exposure of the operator to finger or limb injury from a rotating auger. The dual safety verification system assures that both the auger is lowered into the receiving chamber and that the safety shield is in a protective position before the mixing cycle is initiated.

A typical method for safety interlock verification is presented, as shown in FIG. 6. The safety condition first considered may be, “Is the receiving chamber secured in an upright position 102?” If the system interface detects that the receiving chamber is in a pivoted position, or if the chamber is upright but the control lever 18 is not secured, then the system will inhibit the auger rotation command signal. If the receiving chamber position is satisfied, then the system considers “Is the safety shield in position 104?” The safety shield 24 should be in place to prevent ingredients from displacement from the receiving chamber 14 during mix cycle. Finally, the safety interlock system considers “Is the auger lowered into the receiving chamber 106?” When all conditions are satisfied, the safety interlock system generates an “auger rotation command” signal 110 and delivers the signal to the command microprocessor 28. Next, the command microprocessor 28 processes the function commands as input into the control panel and provides operation command signals to the auger control system 34, thereby controlling the auger drive motor and/or the auger elevation control.

While several particular forms of the invention have been illustrated and described, it will be apparent that various modifications can be made without departing from the spirit and scope of the invention. Accordingly, it is not intended that the scope of the claims be limited except as according to the appended claims.

1. An apparatus for automatically preparing a frozen confection, comprising:
a housing;
a receiving chamber pivotally attached to the housing, the receiving chamber being configured to mix and dispense the frozen confection;
an auger rotatably mounted in the housing to enter the receiving chamber and mix the confection; and
an electronic control system for controlling the vertical and rotational motion of the auger.

2. The apparatus of claim 1, wherein the auger is adjustably mounted to the housing.

3. The apparatus of claim 1, wherein the electronic control system controls a drive motor that rotates the auger.

4. The apparatus of claim 1, wherein the electronic control system is programmed to operate the drive motor for a predetermined time and speed.

5. The apparatus of claim 1, further comprising:
a safety control system which inhibits the auger control system if the safety interlock functions are not in a predetermined state.

6. An apparatus for preparing a frozen dessert product, comprising:
a housing attached to a mountable base, the base being configured to support the housing;
a receiving chamber pivotally attached to the housing;
an auger rotatably adjustably mounted in the housing, the auger being extensible down towards the receiving chamber by means of a control motor;
an electronic control system for controllably mixing the frozen dessert product; and
a plurality of holes in the auger, the holes being configured to project fluid from within the auger outward into the mixing chamber to clean the auger and mixing chamber after use.

7. The apparatus of claim 6, wherein the electronic control system includes a control panel, a safety interlock system, a microprocessor and an auger control system.

8. The apparatus of claim 7, wherein the microprocessor processes function commands input into the control panel with the safety interlock system commands to initiate the auger control system.

9. The apparatus of claim 7, wherein the auger rotation is inhibited if the safety system interlocks are not verified.

10. The apparatus of claim 6, wherein the housing further comprises a moveable safety shield, the safety shield being configured to inhibit operation of the auger when the shield is in an open configuration.

11. The apparatus of claim 6, wherein the electronic control system is programmed to mix the frozen dessert ingredients for a predetermined time.

12. The apparatus of claim 6, wherein the receiving chamber comprises an opening at the upper section of the chamber, the receiving chamber further includes an operable tip that opens to dispense the frozen dessert mixture.

13. A frozen dessert dispensing machine, comprising:
a housing attached to a mountable base, the base being configured to support the housing;
a receiving chamber pivotally attached to the housing;
an auger rotatably mounted in the housing, the auger being capable of extending down towards the receiving chamber and being retracted elevated above the receiving chamber; and
a control system for managing control of the frozen dessert machine operating cycle, wherein the control system includes a control panel, a safety interlock system, a microprocessor and an auger control system.

14. The frozen dessert machine of claim 13, wherein the microprocessor processes function commands input into the control panel with the safety interlock system commands to initiate the auger control system.

15. The frozen dessert machine of claim 13, wherein the auger rotation is inhibited if the safety system interlocks are not verified.

16. The frozen dessert machine of claim 13, wherein the control system controls a drive motor that rotates the auger.

17. The frozen dessert machine of claim 13, wherein the control system controls an AC stepper motor that vertically elevates and lowers the auger.

18. The frozen dessert machine of claim 13, wherein the control system is programmed to operate the drive motor for a predetermined time.

19. A method for preparing a frozen dessert product, comprising:
combining frozen dessert ingredients into a conical mixing receptacle, the receptacle being attached to a frozen dessert apparatus;
mixing the ingredients with injected air, the ingredients being mixed with an auger for a predetermined time, the auger being rotatably mounted to the dessert machine, the vertical and rotational movement of said auger being controlled by a microprocessor; and
dispensing the frozen dessert from the mixing receptacle through a dispensing outlet into a container.

20. The method of claim 19, wherein the frozen dessert ingredient includes fresh fruit.

21. The method of claim 19, wherein the frozen dessert ingredient includes frozen fruit.

22. The method of claim 19, wherein the auger is configured to emit a cleaning fluid through and out of the auger.

23. The method of claim 19, wherein the mixing auger is inhibited by a safety interlock system.

24. The method of claim 19, wherein the mixing auger is inhibited if the mixing receptacle is not in a secured position.

25. The method of claim 19, wherein the mixing auger is inhibited if the mixing auger is not positioned in the receiving chamber.

26. The method of claim 19, wherein the mixing auger is inhibited if a safety shield is not installed on the frozen dessert apparatus.
